(19) United States
(12) Patent Application Publication
(10) Pub. No.: US 2018/0244017 A1
(43) Pub. Date: Aug. 30, 2018

(54) Fastening Structure

(71) Applicant: Tyco Electronics Japan G.K., Kanagawa (JP)

(72) Inventor: Toshiharu Ajisaka, Kanagawa (JP)

(73) Assignee: Tyco Electronics Japan G.K., Kanagawa (JP)

(21) Appl. No.: 15/968,923

(22) Filed: May 2, 2018

Related U.S. Application Data
(63) Continuation of application No. PCT/JP2016/081684, filed on Oct. 26, 2016.

(30) Foreign Application Priority Data
Nov. 2, 2015 (JP) 2015-215422

(51) Int. Cl. B32B 7/08; B32B 15/09; B32B 15/088; B29C 65/60; B29C 65/64; B29C 65/00

(52) U.S. Cl. CPC B32B 7/08; B32B 15/09; B32B 15/088; B29C 65/606; B29L 2031/3002; B29C 66/742; B32B 2307/302; B32B 2605/00; B29K 2995/0013; B29C 65/64

(57) ABSTRACT

A fastening structure comprises a first plate, a second plate, and a sheet member. The first plate has a first passageway with a first diameter. The second plate has a protrusion with a second diameter smaller than the first diameter. The sheet member is disposed on the first plate such that a second passageway of the sheet member communicates with the first passageway of the first plate and the first plate is interposed between the sheet member and the second plate. A portion of the protrusion extends through the first passageway and the second passageway. The first plate is fastened to the second plate by thermal deformation of the portion of the protrusion extending through the first passageway and the second passageway or by overmolding to the portion of the protrusion extending through the first passageway and the second passageway.

### CROSS-REFERENCE TO RELATED APPLICATIONS

This application is a continuation of PCT International Application No. PCT/JP2016/081684, filed on Oct. 26, 2016, which claims priority under 35 U.S.C. § 119 to Japanese Patent Application No. 2015-215422, filed on Nov. 2, 2015.

### FIELD OF THE INVENTION

The present invention relates to a fastening structure and, more particularly, to a fastening structure for fastening a member having a high thermal conductivity.

### BACKGROUND

It is common to fasten a member by heat staking in cameras, mobile phones, or other various pieces of equipment. Japanese Patent Application No. 2003-264025A, for example, shows a fastening structure for heat staking in an electrical connector.

In an automobile application, a metal member having a high thermal conductivity is fastened by resin heat staking in a piece of equipment installed in the automobile. In the case of a piece of equipment installed in an engine compartment of an automobile, it is necessary to ensure the operation of the equipment in a wide temperature range, for example, from −40 to 150° C. The thermal conductivity and the coefficient of thermal expansion, however, is significantly different between metal and resin. Accordingly, for the fastening structure, a diameter of a passageway formed in a metal material through which a protrusion for heat staking, provided on a resin material, penetrates must be larger than the diameter of the protrusion; a gap between a wall face of the passageway and the protrusion is necessary to absorb a dimensional change due to the difference in coefficient of thermal expansion and prevent distortion.

Heat staking, however, requires heating and melting the protrusion. During melting of the protrusion, molten resin can flow into the gap between the protrusion and the wall face of the passageway, filling the gap. Japanese Patent Application No. 2008-162125A discloses a fastening structure having a gap between the protrusion and the passageway, but ensures that the gap is filled. When the gap is filled, the dimensional change due to the coefficient of thermal expansion is no longer absorbed, which can lead to distortion of the fastening structure.

### SUMMARY

A fastening structure comprises a first plate, a second plate, and a sheet member. The first plate has a first passageway with a first diameter. The second plate has a protrusion with a second diameter smaller than the first diameter. The sheet member is disposed on the first plate such that a second passageway of the sheet member communicates with the first passageway of the first plate and the first plate is interposed between the sheet member and the second plate. A portion of the protrusion extends through the first passageway and the second passageway. The first plate is fastened to the second plate by thermal deformation of the portion of the protrusion extending through the first passageway and the second passageway or by overmolding to the portion of the protrusion extending through the first passageway and the second passageway.

### BRIEF DESCRIPTION OF THE DRAWINGS

The invention will now be described by way of example with reference to the accompanying Figures, of which:

FIG. 1 is a perspective view of a component according to an embodiment;

FIG. 2A is a sectional view of a heat-staking protrusion and a first plate of the component prior to heat staking;

FIG. 2B is a sectional view of the heat-staking protrusion, the first plate, and a sheet member prior to heat staking; and

FIG. 2C is a sectional view of the heat-staking protrusion with a head portion, the first plate, and the sheet member after heat staking.

### DETAILED DESCRIPTION OF THE EMBODIMENT(S)

Exemplary embodiments of the present invention will be described hereinafter in detail with reference to the attached drawings, wherein like reference numerals refer to like elements. The present invention may, however, be embodied in many different forms and should not be construed as being limited to the embodiments set forth herein. Rather, these embodiments are provided so that the present disclosure will be thorough and complete and will fully convey the concept of the disclosure to those skilled in the art.

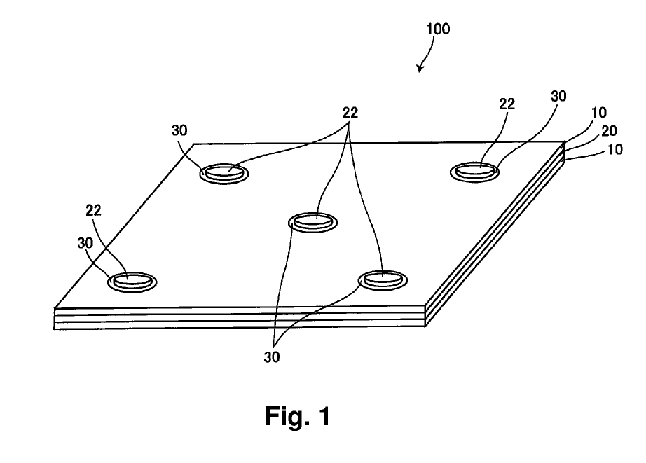

A component 100 according to an embodiment is shown in FIG. 1. In an embodiment, the component 100 is a bus bar installed in an automobile. The component 100 transfers power by a pair of first plates 10, 10, which are each formed of a conductive material. A second plate 20 is interposed between the two first plates 10, 10. The second plate 20 maintains a constant distance between the two first plates 10, 10 and electrically insulates the two first plates 10, 10 from each other. The two first plates 10, 10 are each fastened to the second plate 20 by a fastening structure.

A plurality of head portions 22 for fastening an upper first plate 10 of the pair of first plates 10, 10 to the second plate 20 by heat-staking are shown in FIG. 1. A sheet member 30 is interposed between each head portion 22 and the first plate 10. A lower first plate 10 of the pair of first plates 10, 10 is also fastened to the second plate 20 by a similar heat-staking structure.

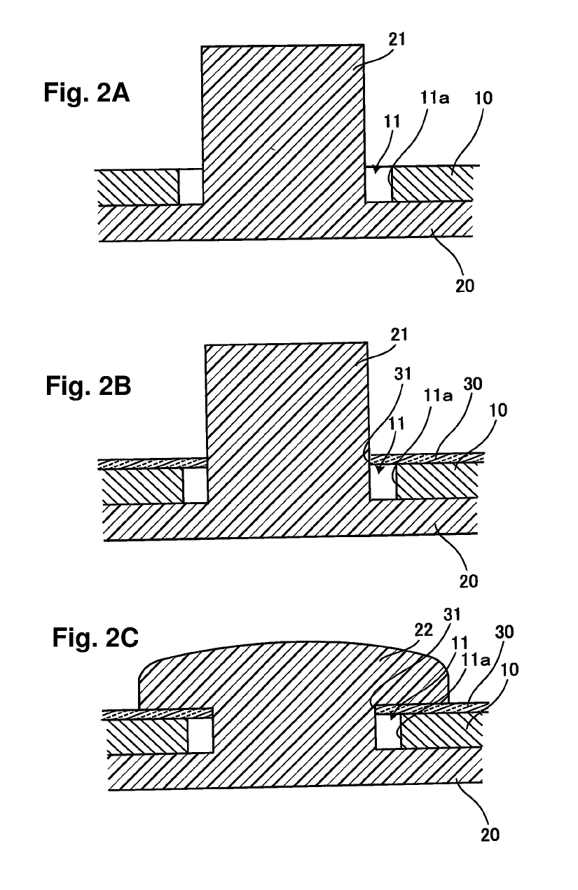

The second plate 20 is formed of a thermoplastic resin and, as shown in FIG. 2, has a plurality of heat-staking protrusions 21. In an embodiment, the second plate 20 is made of a PBT (polybutylene terephthalate) material and the thermal conductivity of the second plate 20 is approximately 0.29 W/mK.

The first plate 10 is formed of a metal material and, as shown in FIG. 2, has a plurality of first passageways 11 extending through the first plate 10. In an embodiment, the first plate 10 is formed of a copper alloy. The thermal conductivity of the first plate 10 is approximately 400 W/mK; the first plate 10 has an extremely high thermal conductivity as compared with the second plate 20.

FIGS. 2A-2C show a process of heat-staking the pair of first plates 10, 10 and the second plate 20 of the component 100. In FIGS. 2A-2C, only one first passageway 11 of an upper first plate 10 of the pair of first plates 10, 10 and one heat-staking protrusion 21 for heat-staking of the second plate 20 are shown. The remaining plurality of heat staking protrusions 21 are similarly heat-staked to the upper first plate 10 and another plurality of heat-staking protrusions 21 of the second plate 20 are similarly heat-staked to the lower first plate 10.

As shown in FIG. 2A, the heat-staking protrusion 21 is inserted into the first passageway 11. A diameter of the first passageway 11 is larger than a diameter of the heat-staking protrusion 21. Accordingly, a gap is formed between the heat-staking protrusion 21 penetrating the first passageway 11 and a wall face 11a of the first passageway 11.

During heat staking, as shown in FIG. 2B, the sheet member 30 is placed on the first plate 10 such that the first plate 10 is interposed between the sheet member 30 and the second plate 20. The sheet member 30 has a second passageway 31 communicating with the first passageway 11 formed in the first plate 10. The second passageway 31 has a diameter that is smaller than the first passageway 11 and slightly larger than the diameter of the heat-staking protrusion 21 such that the portion of the protrusion 21 extending through the second passageway 32 abuts the sheet member 30 at the second passageway 32.

The sheet member 30 has a lower thermal conductivity than the second plate 20; in various embodiments, the sheet member 30 is a fluorine-based sheet having a thermal conductivity of approximately 0.2 W/mK or a polyimide-based sheet. A heatproof temperature of the sheet member 30 is higher than the melting point of the second plate 20. In an embodiment in which the second plate 20 is made of PBT, the sheet member 30 is required to withstand 223° C.

After the sheet member 30 is placed, as shown in FIG. 2B, the heat-staking protrusion 21 is heated and melted by applying a heat-staking head to the heat-staking protrusion 21. The melted heat-staking protrusion 21 cools to form the heat-staking head portion 22 shown in FIG. 2C. The first plate 10 is fastened to the second plate 20 with the head portion 22. The sheet member 30 prevents molten resin from entering the gap between the heat-staking protrusion 21 and the wall face 11a of the first passageway 11. The sheet member 30 also prevents heat at the time of heat staking from being transferred to the first plate 10; heat transfer to the first plate 10 would melt the heat-staking protrusion 21 in the first passageway 11, also leading to a filling of the gap between the heat-staking protrusion 21 and the wall face 11a of the first passageway 11.

The first plate 10 and the second plate 20 are also significantly different in coefficient of thermal expansion. Accordingly, if the environmental temperature becomes high without the gap secured, a distortion occurs at the gap, deforming the component and leading to operation difficulties. In the component 100, a dimensional change due to the difference in coefficient of thermal expansion is absorbed by the gap while the sheet member 30, having a low thermal conductivity, prevents a melted portion of the heat-staking protrusion 21 from entering the gap. Deformation of the component 100 is thereby prevented even in a high-temperature environment.

A fastening structure for fastening the first plate 10 to the second plate 20 by heat staking by heating and melting the heat staking protrusion 21 has been described. However, the fastening structure of the present invention is not limited to fastening by heat staking. In other embodiments a fastening method using overmolding in which molten resin or the like is poured in as to cover a protrusion equivalent to the heat-staking protrusion 21 in the embodiment described above may also be used. In addition, the present invention is not limited to the first plate 10 and the second plate 20. The fastening structure of the present invention is applicable in a wide range of applications in which a member having a high thermal conductivity is fastened by heat staking or overmolding.

What is claimed is:

1. A fastening structure, comprising:
a first plate formed of a first material with a first thermal conductivity and having a first passageway with a first diameter;
a second plate formed of a second material with a second thermal conductivity less than the first thermal conductivity and having a protrusion with a second diameter smaller than the first diameter; and
a sheet member disposed on the first plate such that a second passageway of the sheet member communicates with the first passageway of the first plate and the first plate is interposed between the sheet member and the second plate, the sheet member formed of a third material having a third thermal conductivity less than the second thermal conductivity, a portion of the protrusion extends through the first passageway and the second passageway, the first plate is fastened to the second plate by thermal deformation of the portion of the protrusion extending through the first passageway and the second passageway or by overmolding to the portion of the protrusion extending through the first passageway and the second passageway.

2. The fastening structure of claim 1, wherein the second passageway has a third diameter smaller than the first diameter of the first passageway.

3. The fastening structure of claim 2, wherein the third diameter of the second passageway is slightly larger than the second diameter of the protrusion.

4. The fastening structure of claim 3, wherein the sheet member abuts the protrusion at the second passageway.

5. The fastening structure of claim 1, wherein the first material is a metal material.

6. The fastening structure of claim 5, wherein the first material is a copper alloy.

7. The fastening structure of claim 5, wherein the second material is a thermoplastic resin.

8. The fastening structure of claim 7, wherein the second material is a polybutylene terephthalate material.

9. The fastening structure of claim 7, wherein the first plate is fastened to the second plate by heat staking of the protrusion.

10. The fastening structure of claim 7, wherein the third material is a fluorine-based or a polyimide-based material.

11. The fastening structure of claim 10, wherein a heatproof temperature of the third material is higher than a melting point of the second material.

12. The fastening structure of claim 1, wherein a gap is disposed between the protrusion and a wall face of the first passageway.

13. The fastening structure of claim 12, wherein the sheet member retains a liquid material produced by thermal deformation or overmolding on a side of the sheet member opposite the first plate.

14. The fastening structure of claim 13, wherein the sheet member prevents the liquid material from entering into the gap between the protrusion and the wall face of the first passageway.

15. The fastening structure of claim 1, wherein the first material has a different coefficient of thermal expansion than the second material.
